(19) United States
(12) Patent Application Publication
(10) Pub. No.: US 2004/0252118 A1
(43) Pub. Date: Dec. 16, 2004

(54) Data display device, data display method and computer program product

(75) Inventors: Norio Yabe, Kawasaki (JP); Makoto Misawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/766,838

(22) Filed: Jan. 30, 2004

(30) Foreign Application Priority Data
Mar. 31, 2003 (JP) 2003-095321

(51) Int. Cl. G06T 1/00

(52) U.S. Cl. 345/418

(57) ABSTRACT

A data display device includes an appearance characteristic obtaining unit and a display control unit. The appearance characteristic obtaining unit obtains appearance characteristic of each of data objects that are displayed on a screen by similar data display ways. The data objects represent pieces of information to be displayed on the screen respectively. The display control unit changes appearance of at least one of the data objects so that the at least one of the data objects is displayed in a distinct appearance, depending on the appearance characteristic obtained.

### BACKGROUND OF THE INVENTION

1) Field of the Invention

The present invention relates to a data display device that on a screen displays data display, which presents information in a way that text alone cannot, more particularly, to a data display device by which individual pieces of information can be made distinctly visible even if the pieces are displayed by a common way.

2) Description of the Related Art

Data display devices, which display data display that presents information in a way that text alone cannot, have been used (for example, see Japanese Patent Application Laid-Open No. 2000-020049). More specifically, such conventional data display devices display collection of digital values as data display such as fill, plot, line contour, or vector.

However, in the conventional data display devices, when individual pieces of information are presented by a common data display, display of one piece of information overlaps with or covers display of the other pieces. As a result, the information tends to appear indistinct due to opaqueness at the overlapped or covered portion.

### SUMMARY OF THE INVENTION

It is an object of the present invention to at least solve the problems in the conventional technology.

An object display device according to one aspect of the present invention includes an appearance characteristic obtaining unit and a display control unit. The appearance characteristic obtaining unit obtains appearance characteristic of each of data objects that are displayed on a screen by similar data display ways. The data objects represent pieces of information to be displayed on the screen respectively. The display control unit changes appearance of at least one of the data objects so that the at least one of the data objects is displayed in a distinct appearance, depending on the appearance characteristic obtained.

An object display method according to another aspect of the present invention includes obtaining appearance characteristic of each of data objects that are displayed on a screen by similar data display ways. The data objects represent pieces of information to be displayed on the screen respectively. The object display method also includes changing appearance of at least one of the data objects so that the at least one of the data objects is displayed in a distinct appearance, depending on the appearance characteristic obtained.

The computer program product according to still another aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a data display device according to a first embodiment of the present invention;

FIG. 2 is a drawing that explains a weighting process for each data display way;

FIG. 3 is a drawing that explains a display control process;

FIG. 4 is a flow chart showing the process steps of the data display device according to the first embodiment;

FIG. 5 is a sample screen that is output on the output unit;

FIG. 6 is a drawing illustrating the structure of a computer system according to a second embodiment of the present invention; and

FIG. 7 is a block diagram of the main unit of the computer system shown in FIG. 6.

### DETAILED DESCRIPTION

Exemplary embodiments of the data display device, a data display device, and a computer program product according to the present invention will be explained next with reference to the accompanying drawings.

A data display device and a data display method of a first embodiment will be explained first, and then a computer system that executes a computer program product for displaying data according to a second embodiment will be explained. Finally, various modifications of the present invention will be explained.

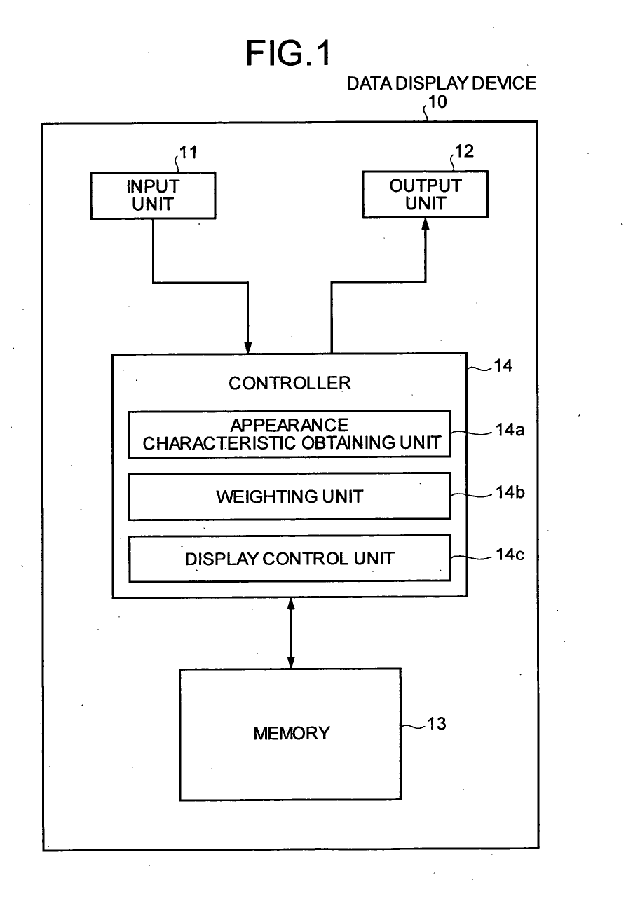

An overview and main features of the data display device according to the first embodiment will be explained first. FIG. 1 is a block diagram of the data display device according to the first embodiment of the present invention. The data display device 10 displays information by a predetermined data display way, on a screen.

The data display 10 is characterized in data display process that includes obtaining characteristics of individual pieces of information displayed by similar data display ways; and changing appearances of the pieces depending on the characteristics so that the pieces are distinctly distinguished from each other. As a result, this data display process allows the information to be distinctly visualized even if individual pieces of the information are presented on a screen by similar data display ways.

For example, first, from objects (hereinafter, “data objects”) corresponding to pieces of information which is collection of digital values, fill area and number of colors of individual data objects each displayed by a filled object are obtained. Then, each data object is applied with a weighted value so that the data object having a large fill area and few colors is placed in a lower layer. Finally, the transparency of the data object applied with a lower weighted value is increased.

Thus, this data display device prevents data objects on a screen from being indistinct due to opaqueness at the overlapped or covered portion of the objects, and therefore allows the data objects to be distinctly visualized even if individual data objects are presented on the screen by similar data display ways.

The structure of the data display device 10 according to the first embodiment will be explained next. As shown in FIG. 1, the data display device 10 includes an input unit 11, an output unit 12, a memory 13, and a controller 14.

The input unit 11 is a means by which various data are entered. The input unit 11 can be a keyboard, mouse or a track ball. More specifically, the input unit 11 receives data (which consists of collection of digital values) which can be displayed on the screen, and instructions for a data display way (e.g. fill, plot, line contour, or vector) by which the data is represented on the screen as the data objects. The input unit 11 in the present invention also receives the data as a plurality of pieces of information for each data display way.

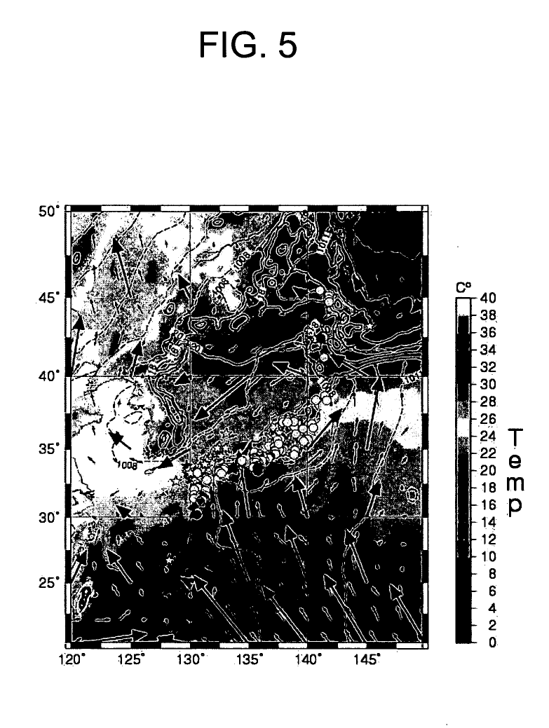

The output unit 12 is a means on which various data are output. More specifically, the output unit 12 displays the result (see FIG. 5) of the processes carried out by a appearance characteristic obtaining unit 14a, a weighting unit 14b, and a display control unit 14c, which are included in the controller 14.

The memory 13 is a storage unit which stores data and programs necessary for the processes of the controller 14. More specifically, the memory 13 stores physical data containing the digital values to be handled and a visualizing software program that realizes the data display ways.

The controller 14 has an internal memory for storing control programs (e.g. the operating system), programs for regulating various processes, and the required data. With the help of these programs and data, the controller 14 carries out various processes. Particularly, in the context of the present invention, the controller 14 includes the appearance characteristic obtaining unit 14a, the weighting unit 14b, and display control unit 14c.

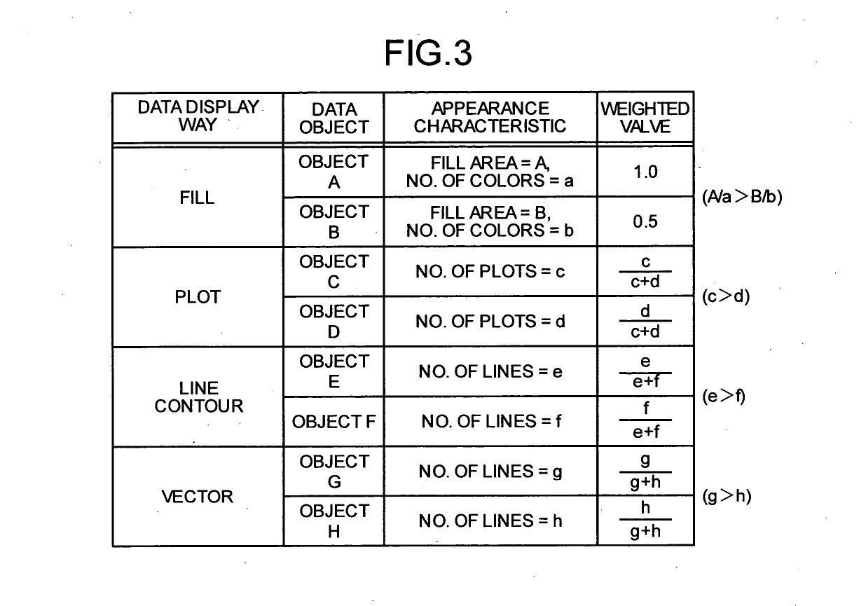

The appearance characteristic obtaining unit 14a obtains the appearance characteristic of each of the data objects presented by similar data display ways. For instance, as shown in FIG. 3, for data object A and data object B which are presented by the data display way “fill”, the appearance characteristic obtaining unit 14a obtains from the memory 13 the appearance characteristics “fill area and/or number of colors”. For data object C and data object D which are presented by the data display way “plot”, the appearance characteristic obtaining unit 14a obtains from the memory 13 the appearance characteristic “number of plots”. For data E and data F which are presented by the data display way “line contour”, the appearance characteristic obtaining unit 14a obtains from the memory 13 the appearance characteristic “number of lines”. For data object G and data object H which are presented by the data display way “vector” as well, the appearance characteristic obtaining unit 14a obtains from the memory 13 the appearance characteristic “number of lines”.

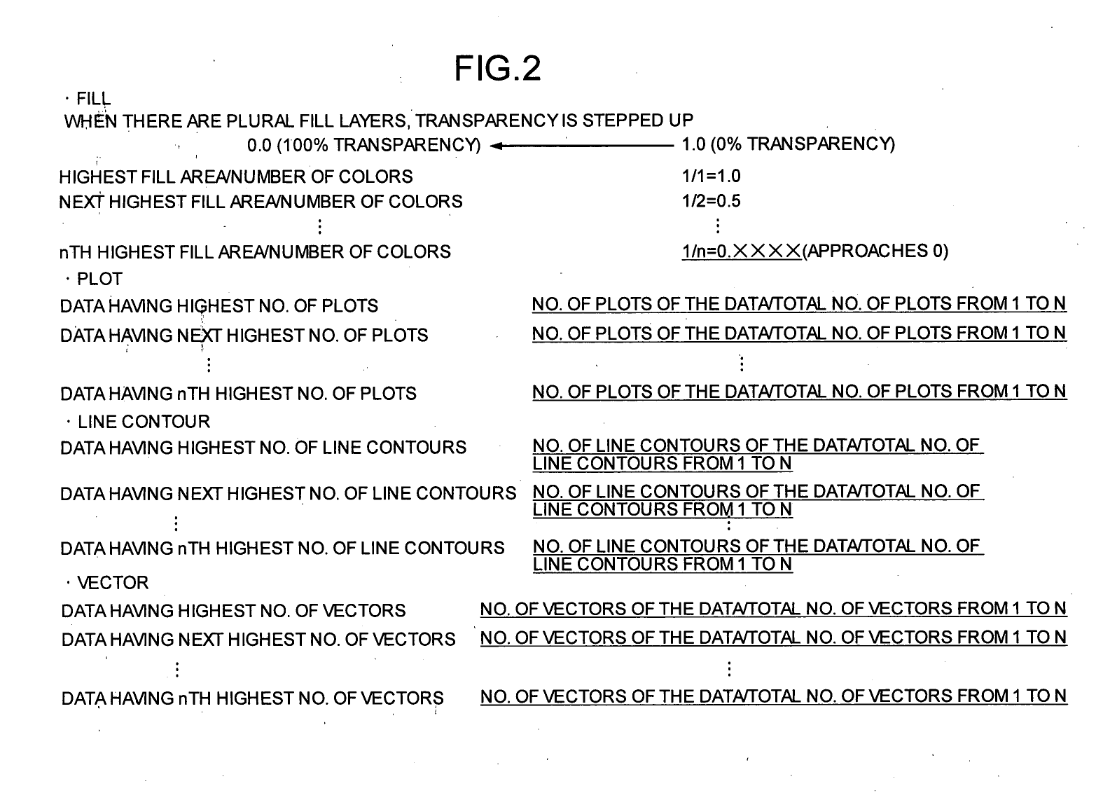

The weighting unit 14b applies a weighted value, based on the appearance characteristic obtained by the appearance characteristic obtaining unit 14a, each of the plural data objects presented by similar data display ways. More specifically, as shown in FIG. 2, the weighting unit 14b applies a weighted value to each of data object A and object data B (the data objects which are presented by the data display way “fill”) so that the data object having a large fill area and few colors is placed in a lower layer. The weighting unit 14b applies a weighted value to each of data object C and data object D (the data objects which are presented by the data display way “plot”) so that the data object having more number of plots is placed in a lower layer. The weighting unit 14b applies a weighted value to each of data object E and data object F (the data objects which are presented by the data display way “line contour”) so that the data object having more number of lines is placed in a lower layer. Similarly, the weighting unit 14b applies a weighted value to each of data object G and data object H (the data objects which are presented by the data display way “vector”) so that the data object having more number of lines is placed in a lower layer.

The display control unit 14c changes the appearance of each data object so that the data object is displayed in a distinct appearance, depending on its appearance characteristic obtained by the appearance characteristic obtaining unit 14a. More specifically, as shown in FIG. 3, the display control unit 14c displays the data object in a distinct appearance, depending on the weighted value.

In the case of data object A and data object B (the data objects which are presented by the data display way “fill”), for instance, the display control unit 14c superposes data object B on data object A and differentiates the appearances of data object A and data object B by setting the transparency of data object B to 0.5 (that is, lowers the weighted value that represents the transparency, and increases the transparency). In the case of data object C and data object D (the data objects which are presented by the data display way “plot”), the display control unit 14c superposes data object D on data object C and differentiates the appearances of data object C and data object D by making the plot display of data object C black and small and that of data object D large and light in color. In the case of data object E and data object F (the data objects which are presented by the data display way “line contour”), the display control unit 14c superposes data object F on data object E and differentiates the appearances of data object E and data object F by showing the lines of data object E as thin lines and those of data object F as thick lines. Similarly, in the case of data object G and data object H (the data objects that are presented by the data display way “vector”), the display control unit 14c superposes data object H on data object G, and differentiates the appearances of data object G and data object H by showing the vectors of data object G as thin arrows and those of data object H as thick arrows (see FIG. 2 and FIG. 3).

The display control unit 14c then creates a display screen by placing the data object represented by the data display way “fill” (data object A and data object B) in the lowest layer and superposes on this fill data object the data object presented by the data display way “line contour” (data object E and data object F), the data object presented by the data display way “vector” (data object G and data object H), and the data object presented by the data display way “plot” (data object C and data object D), in that order (see FIG. 5).

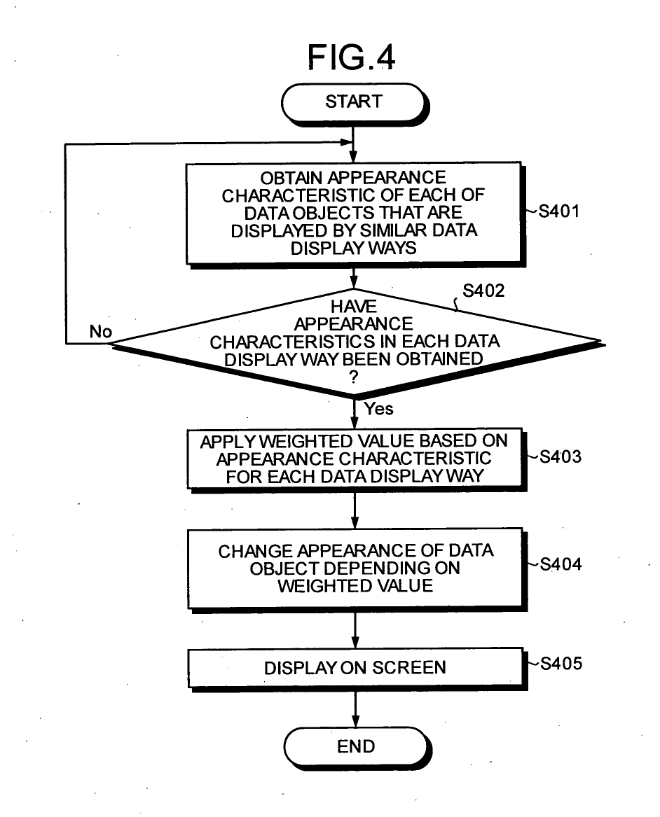

FIG. 4 is a flow chart illustrating the process steps of the data display device according to the first embodiment. The appearance characteristic obtaining unit 14a obtains from the memory 13 the appearance characteristics “fill area and/or number of colors” for data object A and data object B which are data objects presented by the data display way “fill”, the appearance characteristic “number of plots” for data object C and data object D which are data object presented by the representation method “plot”, the representation characteristic “number of lines” for data E and data F which are data presented by the data display way “line contour”, and again the appearance characteristic “number of lines” for data object G and data object H which are data object presented by the data display way “vector” (step S401).

Once all the appearance characteristics of each data display way has been obtained (“Yes” at step S402), as shown in FIG. 2, the weighing unit 14b applies a weighted value to each of data object A and data object B (the data object which are presented by the data display way “fill”) so that the data object having a large fill area and few colors is placed in a lower layer, data object C and data object D (the data object which are presented by the data display way “plot”) so that the data object having more number of plots is placed in a lower layer, data object E and data object F (the data object which are presented by the data display way “line contour”) so that the data object having more number of lines is placed in a lower layer, and data object G and data object H (the data object which are presented by the data display way “vector”) so that the data object having more number of lines is placed in a lower layer (step S403).

Next, as shown in FIG. 2 and FIG. 3, in the case of data object A and data object B (the data object which are presented by the data display way “fill”), the display control unit 14c superposes data object B on data object A and differentiates the appearances of data object A and data object B by setting the transparency of data object B to 0.5 (that is, lowers the weighted value that represents the transparency, and increases the transparency). In the case of data object C and data object D (the data object which are presented by the data display way “plot”), the display control unit 14c superposes data object D on data object C and differentiates the appearances of data object C and data object D by making the plot display of data object C black and small and that of data object D large and light in color. In the case of data object E and data object F (the data object which are presented by the data display way “line contour”), the display control unit 14c superposes data object F on data object E and differentiates the appearances of data object E and data object F by showing the lines of data object E as thin lines and those of data object F as thick lines. Similarly, in the case of data object G and data object H (the data object that are presented by the data display way “vector”), the display control unit 14c superposes data object H on data object G, and differentiates the appearances of data object G and data object H by showing the vectors of data object G as thin arrows and those of data object H as thick arrows (step S404).

The display control unit 14c then creates a display screen by making the data represented by the representation method “fill” (data A and data B) the bottom-most data and superposes on this data the data represented by the data display way “line contour” (data object E and data object F), the data object presented by the data display way “vector” (data object G and data object H), and the data object presented by the data display way “plot” (data object C and object D), in that order (see FIG. 5) and displays the display screen on the output unit 12 (step S405).

Thus in the data display device according to the first embodiment, the appearance characteristic of each of the plural data objects presented by similar data display ways is obtained, and each data object is displayed in a distinct appearance based on its appearance characteristic. Therefore, plural data objects are distinctly visualized even if they are represented by similar data display ways.

The data display device and the data display method explained in the first embodiment can be realized by executing programs pre-installed in a computer system such as a personal computer or a workstation. A computer system that executes programs that perform functions similar to those of the data display device (data display method) explained in the first embodiment will be explained next.

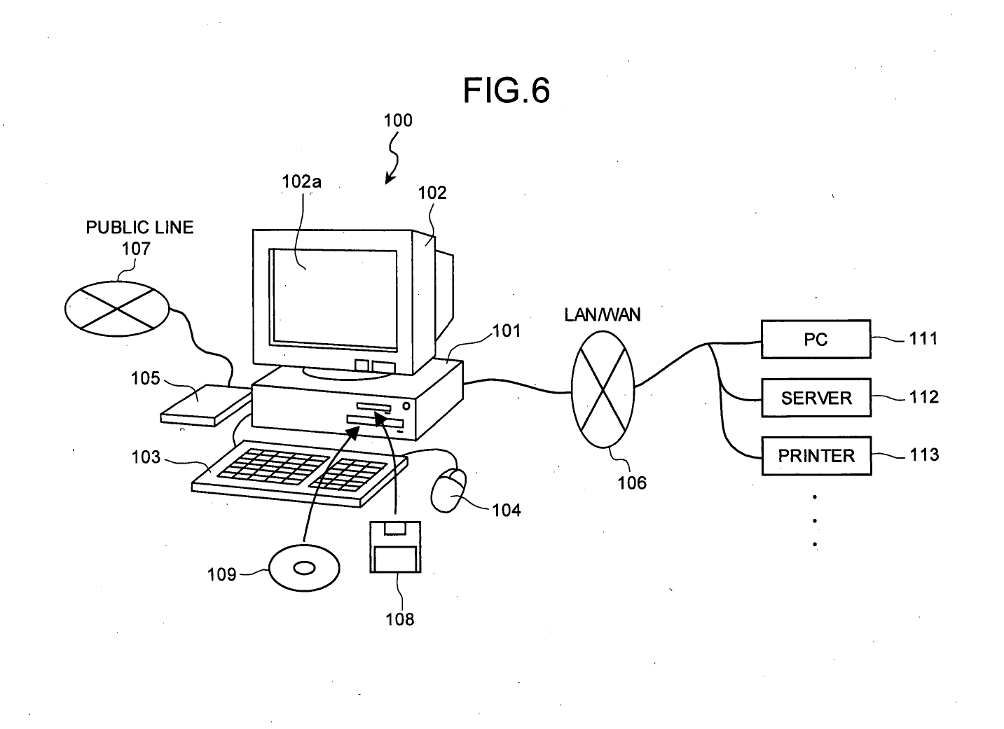

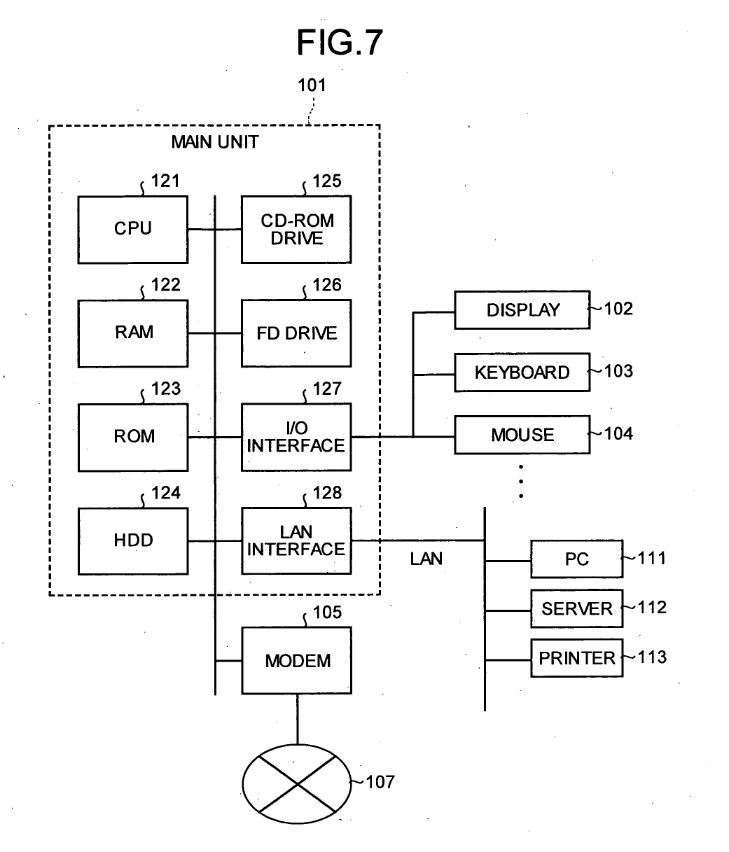

FIG. 6 shows a structure of the computer system according to the second embodiment of the present invention. FIG. 7 is a block diagram of the main unit of the computer system shown in FIG. 6. The computer system 100 according to the second embodiment of the present invention includes a main unit 101, a display 102 that displays data such as images on a display screen 102a in accordance with the instructions from the main unit 101, a keyboard 103 for inputting data into the computer system 100, and a mouse 104 for pointing to any item on the display screen 102a of the display 102.

The main unit 101 of the computer system 100 includes, a central processing unit 102, a RAM 122, a ROM 123, a hard disk drive (HDD) 124, a CD-ROM drive 125 that receives a CD-ROM 109, a flexible disk (FD) drive 126 that receives a FD 108, an I/O interface 127 that connects the display 102, the keyboard 103, and the mouse 104, and a LAN interface 128 that connects to a local area network or a wide area network (LAN/WAN) 106.

A modem 105 is connected to the computer system 100 for connecting to a public line 107 such as the Internet. Another computer system (PC) 111, a server 112, and a printer 113 are connected to the computer system 100 via the LAN interface 128 and the LAN/WAN 106.

The computer system 100 realizes the functions of the data display device (data display method) by reading and executing the programs recorded in a specific recording medium. The recording medium may include a portabletype in the form of FD 108, CD-ROM 109, MO disk, DVD disk, magneto optic disk, IC card, etc., or a ‘fixed’ type in the form of HDD 124 integral to the computer system 100, RAM 122, ROM 123, etc, or a ‘communication medium’ in the form of public circuit 107 connected through the modem 105 or LAN/WAN 106 by which the computer system 100 is connected to another computer system 111 and the server 112 and which stores the transmitted program for a short duration.

In other words, the programs that make the computer realize the data display device and the data display method are stored in the portable medium, fixed medium or communication medium described above in a readable manner, and the computer system 100 executes these programs by reading the programs stored in the recording medium. Apart from the computer system 100, the programs for data display can also be executed by another computer system 111 or the server 112 or jointly by another computer system 111 and the server 112.

Although the invention has been described with respect to a specific embodiment, the appended claims are not to be thus limited but are to be construed as embodying all modifications and alternative constructions that may occur to one skilled in the art which fairly fall within the basic teaching herein set forth.

In the present embodiment, weighting of plural data objects presented by similar data display ways is performed based on the appearance characteristic of the data object. However, the data object themselves may be applied with a weighted value and the predetermined data which needs to be accentuated may be highlighted.

Moreover, all the manual processes explained in the present embodiment can be entirely or in part carried out automatically. The sequence of processes, the sequence of controls, specific names, and data including various parameters (e.g. weighted value) can be altered as required unless otherwise specified.

The constituent elements of the device illustrated are merely conceptual and may not necessarily physically resemble the structures shown in the drawings. For instance, the data display device need not necessarily have the structure that is illustrated. The device as a whole or in part can be broken down or integrated either functionally or physically in accordance with the load or how the device is to be used.

The process functions executed by each device may be realized, entirely or in part, by the central processing unit and the programs executed by the CPU, or by hardware through wired logic.

According to the present invention, the appearance characteristic of each of the plural data objects presented by similar data display ways is obtained, and each data object is displayed in a distinct appearance based on its appearance characteristic. Consequently, a data display device is obtained in which plural data objects can be distinctly visualized even if they are presented by similar data display ways.

According to the present invention, the appearance characteristic of each of the plural data object presented by a fill data display way is obtained, and each data object is displayed in a distinct appearance based on its appearance characteristic. Consequently, a data display device allows the information to be distinctly visualized even if individual pieces of the information are presented on a screen by the fill data display way.

According to the present invention, the appearance characteristic of each of the plural data objects presented by a vector data display way is obtained, and each data object is displayed in a distinct appearance based on its appearance characteristic. Consequently, a data display device allows the information to be distinctly visualized even if individual pieces of the information are presented on a screen by the vector data display way.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data display device comprising:
an appearance characteristic obtaining unit that obtains appearance characteristic of each of data objects that are displayed on a screen by similar data display ways, the data objects representing pieces of information to be displayed on the screen respectively; and
a display control unit that changes appearance of at least one of the data objects so that the at least one of the data objects is displayed in a distinct appearance, depending on the appearance characteristic obtained.

2. The data display device according to claim 1, wherein the data objects includes a fill object that is presented by a fill data display way.

3. The data display device according to claim 1, wherein the data objects includes a plot object that is presented by a plot data display way.

4. The data display device according to claim 1, wherein the data objects includes a line contour object that is presented by a line contour data display way.

5. The data display device according to claim 1, wherein the data objects includes a vector object that is presented by a vector data display way.

6. A data display method comprising:
obtaining appearance characteristic of each of data objects that are displayed on a screen by similar data display ways, the data objects representing pieces of information to be displayed on the screen respectively; and
changing appearance of at least one of the data objects so that the at least one of the data objects is displayed in a distinct appearance, depending on the appearance characteristic obtained.

7. A computer program product for displaying data on a screen, including computer executable instructions stored on a computer readable medium, wherein the instructions, when executed by the computer, cause the computer to perform:
obtaining appearance characteristic of each of data objects that are displayed on the screen by similar data display ways, the data objects representing pieces of information to be displayed on the screen respectively; and
changing appearance of at least one of the data objects so that the at least one of the data objects is displayed in a distinct appearance, depending on the appearance characteristic obtained.
